(19) United States
(12) Patent Application Publication
(10) Pub. No.: US 2011/0282741 A1
(43) Pub. Date: Nov. 17, 2011

(54) METHOD FOR OFFERING ADVERTISEMENT ACCORDING TO SEARCH INTENTION SEGMENTATION AND SYSTEM FOR EXECUTING THE METHOD

(75) Inventor: Sung Bum Park, Seongnam-si (KR)

(73) Assignee: NHN Business Platform Corporation, Seongsam-si (KR)

(21) Appl. No.: 12/810,926

(22) PCT Filed: Dec. 13, 2008
(86) PCT No.: PCT/KR2008/007399

§ 371 Date: Sep. 28, 2010

(30) Foreign Application Priority Data
Dec. 27, 2007 (KR) 1020070138820

(51) Int. Cl. G06Q 30/00

(52) U.S. Cl. 705/14.54

(57) ABSTRACT

Disclosed are an advertisement providing method and system. The advertisement providing method, including: defining a search intention for each keyword and a content type for each search intention; and providing, when a user inputs the keyword, an advertisement content list based on a search intention of the inputted keyword.

### CROSS-REFERENCE TO RELATED APPLICATIONS

This application is the National Stage of International Application No. PCT/KR2008/007399, filed Dec. 13, 2008, and claims priority from and the benefit of Korean Patent Application No. 10-2007-0138820, filed on Dec. 27, 2007, which are both hereby incorporated by reference for all purposes as if fully set forth herein.

### BACKGROUND OF THE INVENTION

1. Field of the Invention

The present invention relates to an advertisement providing system, and more particularly, to an advertisement providing system and method which may realize an appropriate marketing and provide an advertisement based on a user's intention.

2. Discussion of the Background

Most information resources may be obtained through networks such as the Internet in the information age. Also, the commercialization of a network having a great purchase potential is rapidly progressed, and online advertisement that uses the Internet for marketing to attract Internet users has been developed.

Online advertisement displays web-based contents such as an image and a video including advertisement contents to Internet users. A banner advertisement is one of the most common online advertising forms. A banner advertisement displays a banner including advertisement contents on an Internet browser.

In particular, a search engine that retrieves information in response to a request from an Internet user and provides the retrieved information to the user may easily obtain customers and increase an advertising effect. Accordingly, a search engine may be currently a major marketing media.

In general, an Internet user may input a keyword in a search site connected through a network, and search results associated with the keyword (advertisement information of advertisers) may be listed on the search site and provided to the Internet user.

In a service providing a search result list, a number of advertisement exposures, a number of page views with respect to a website of an advertiser, and the like may depend on a location where advertisement information of the advertiser is located in the search result list. That is, an advertising effect may be affected by the exposure location of the advertisement information.

Accordingly, a manger of a search site providing a search result list sets a fee-based advertisement area for an area showing a high advertising effect in the search result list, and presents an advertisement in the set advertisement area. That is, a manager of a search site may impose a predetermined advertisement cost to an advertiser, and thereby may earn high profits. Also, the advertiser may obtain a high advertising effect by presenting an advertisement in a location desired by the advertiser.

That is, what an advertiser desires for online advertisement is that advertisement information of the advertiser is continuously exposed to Internet users to increase sales of a product of the advertiser.

However, online advertisement is merely a form of unsystematically displaying of a banner or simply providing advertisement information including a keyword. In online advertisement, since a search intention of an Internet user may not be ascertained, it may not be determined whether a user searches for information acquisition before purchase or searches to decide on a purchase. Also, desired information may not be selectively provided based on the user's search intention.

Online advertisement in a conventional art may not analyze a search intention and characteristics of a customer, and thus an Internet user is required to retrieve necessary information by himself/herself, which is a limit of online marketing.

### SUMMARY OF THE INVENTION

An aspect of the present invention provides an advertisement providing method and system which supports a more sophisticated marketing through a classification of a search intention.

An aspect of the present invention also provides an advertisement providing method and system which determines a search intention of a user, and thereby may present advertisement information appropriate for the search intention.

According to an aspect of the present invention, there is provided an advertisement providing method, including: defining a search intention for each keyword and a content type for each search intention; and providing, when a user inputs the keyword, an advertisement content list based on a search intention of the inputted keyword.

The defining may include: defining the search intention as at least two stages; collecting keywords; setting the search intention for each keyword in each of the at least two stages based on a characteristic of each of the keywords and a characteristic of an advertisement content associated with each of the keywords; dividing a content type of an advertisement content into at least two content types; and setting the content type corresponding to the defined search intention of each of the at least two stages.

The providing of the advertisement content list may include: determining the search intention of the keyword inputted by the user; determining the content type of the advertisement content corresponding to the search intention of the keyword; generating the advertisement content list corresponding to the search intention from advertisement contents associated with the keyword; and presenting the advertisement content list corresponding to the search intention.

According to another aspect of the present invention, there is provided an advertisement providing system, including: a database storing an advertisement of an advertiser in association with a predetermined content type for each advertisement and storing a predetermined search intention for each keyword and a content type for each search intention; and an advertisement providing unit providing, when a user inputs a keyword, an advertisement content list based on a search intention of the inputted keyword.

The advertisement providing unit may include: a search intention determination unit determining the search intention of the inputted keyword and determining a content type corresponding to the search intention; and an advertisement presentation unit generating an advertisement content list corresponding to the search intention from advertisement contents associated with the keyword and presenting the generated advertisement content list.

According to an embodiment of the present invention, an advertisement providing system and method may support a more sophisticated marketing based on a search intention of a user, and thereby may increase an advertisement income of a search engine marketer and develop a new marketing using synergy of a search advertisement and a direct advertisement.

Also, according to an embodiment of the present invention, an advertisement providing system and method may provide a user with advertisement information appropriate for a search intention of the user, and thereby may support an online advertisement for behavior targeting.

Also, according to an embodiment of the present invention, an advertisement providing system and method may directly present advertisement information appropriate for a search intention of a user, and thereby may reduce an unnecessary information search by a user and improve a user's satisfaction of search results.

### BRIEF DESCRIPTION OF THE DRAWINGS

FIG. 1 is a flowchart illustrating an advertisement providing method according to an embodiment of the present invention;

FIG. 2 is a flowchart illustrating an operation of defining a search intention for each keyword and a content type for each search intention;

FIG. 3 is a diagram illustrating an operation of sorting a search intention based on a characteristic of a keyword and a characteristic of an advertisement content associated with the keyword;

FIG. 4 is a diagram illustrating an operation of dividing a content type;

FIG. 5 is a diagram illustrating an operation of collecting keywords;

FIGS. 6 and 7 are diagrams illustrating examples of a screen providing an advertisement content based on a search intention of a user;

FIG. 8 is a diagram illustrating a relationship associated with an advertisement providing system according to an embodiment of the present invention; and

FIG. 9 is a block diagram illustrating a configuration of an advertisement providing system according to an embodiment of the present invention.

### DETAILED DESCRIPTION OF THE ILLUSTRATED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

The present invention relates to an advertisement providing method and system providing an advertisement content based on a search intention of a user.

Specifically, the advertisement providing method and system may define a search intention for each keyword and a content type for each search intention, and thereby may ascertain a search intention of a user and selectively provide an advertisement content based on the search intention of the user.

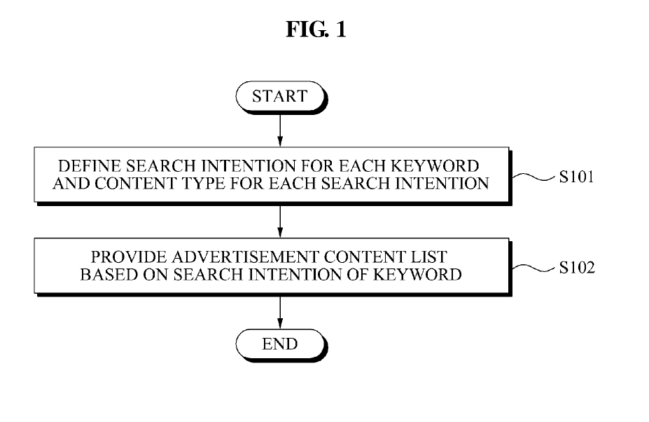

FIG. 1 is a flowchart illustrating an advertisement providing method according to an embodiment of the present invention.

In operation S101, an advertisement providing system according to an embodiment of the present invention may define and maintain a search intention for each keyword and a content type for each search intention in advance. The advertisement providing system may define the search intention for each keyword in advance. Also, the advertisement providing system may define the content type for each search intention to selectively provide an advertisement content associated with the keyword based on the search intention.

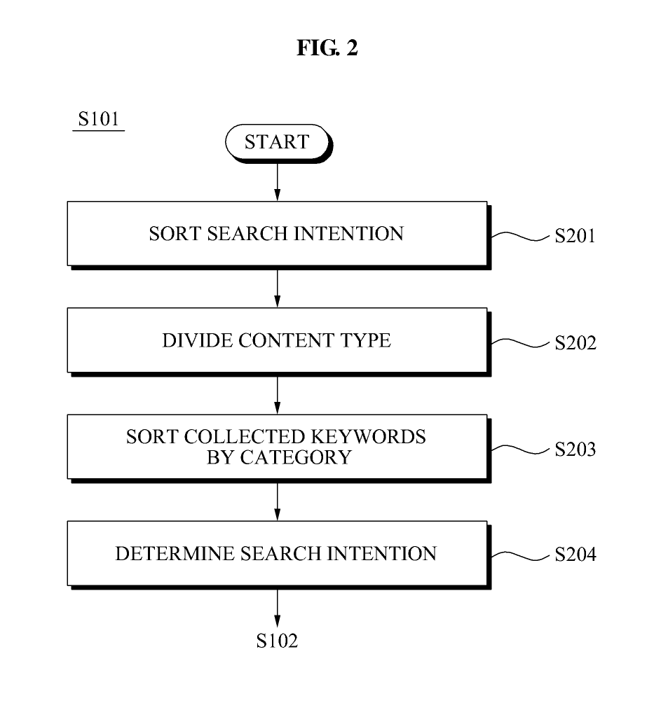

The defining in operation S101 is described in greater detail with reference to FIG. 2.

In operation S102, when the user inputs a keyword, the advertisement providing system may selectively provide an advertisement content list based on a predetermined search intention of the inputted keyword. The advertisement providing system may determine the search intention of the inputted keyword, and then determine the content type determined in advance with respect to the determined search intention. Accordingly, the advertisement providing system may selectively provide the advertisement content list corresponding to the search intention from among advertisement contents associated with the keyword.

FIG. 2 is a flowchart illustrating an operation of defining in operation S101 of FIG. 1 in detail.

It is required to define a search intention and a content type first in order to define the search intention for each keyword and the content type for each search intention.

In operation S201, the advertisement providing system may sort the search intention based on a characteristic of a keyword and a characteristic of an advertisement content associated with the keyword. The advertisement providing system may define the search intention as at least two stages. The search intention may indicate a purchase-related process from information acquisition to an actual purchase. That is, the purchase-related process may be divided into the at least two stages.

Specifically, the characteristic of the keyword may be divided into at least two keyword characteristics, and the characteristic of the advertisement content may be divided into at least two content characteristics. The search intention may be divided into the at least two stages based on the characteristic of the keyword and the characteristic of the advertisement content.

A keyword for information retrieval may have a characteristic intended for information acquisition in association with a purchase and a characteristic intended for an actual purchase. Accordingly, the characteristic of the keyword may be divided into the at least two keyword characteristics.

Also, advertisement contents for providing information may have an information-oriented content characteristic in association with the purchase and a purchase-oriented content characteristic. Accordingly, the characteristic of the advertisement content may be divided into the at least two content characteristics.

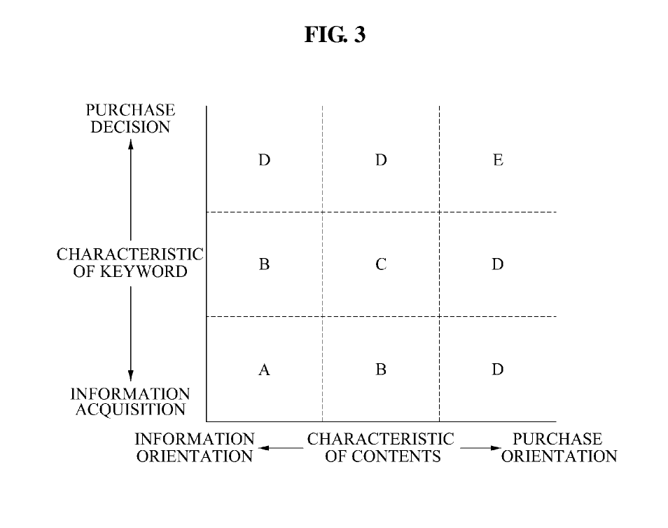

As illustrated in FIG. 3, when the characteristic of the keyword is divided into three keyword characteristics, and the characteristic of the advertisement content is divided into three content characteristics, a search intention of a keyword may be divided into nine stages. Each stage may be applied as the search intention, and at least two stages may be recognized as a single stage and applied. For example, the search intention divided into the nine stages may be applied as five stages (A, B, C, D, and E) as illustrated in FIG. 3.

In operation S202, the advertisement providing system may divide a content type of an advertisement content into at least two content types according to the characteristic of the advertisement content. The content type of the advertisement content may be divided into contents providing information-oriented advertisement information and contents providing purchase-oriented advertisement information.

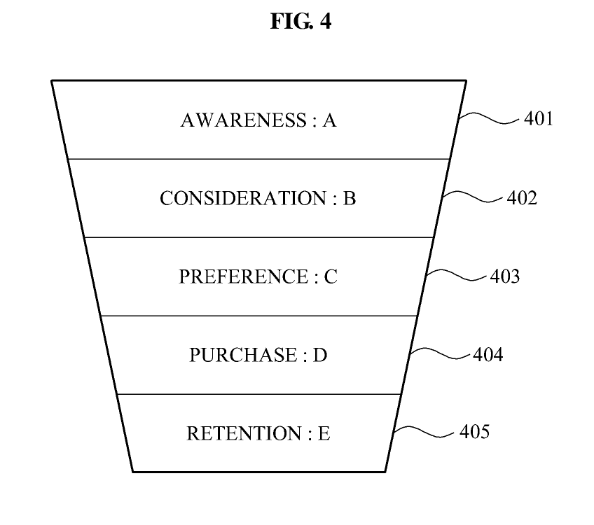

For example, as illustrated in FIG. 4, an advertisement content associated with a purchase may be divided into five content types according to the characteristic of the advertisement content. The five content types may be divided into awareness information 401, consideration information 402, preference information 403, purchase information 404, and retention information 405 in association with a predetermined keyword. The awareness information 401 may provide official information such as a name of a product and a brand, which is basic information. The consideration information 402 may provide comparative advantage information of a product based on reputation information. The preference information 403 may provide detailed information about a product such as a function, feature, and the like of the product or a brand. The purchase information 404 may provide information about an actual purchase such as a purchase condition, purchase event, and the like. The retention information 405 may provide reputation information from users such as a user's comment on the product, and the like.

The advertisement providing system may define the content type for each search intention, after dividing and defining the content type and the search intention. For example, a search intention of each of the stage A, the stage B, the stage C, the stage D, and the stage E may correspond to the awareness information 401, the consideration information 402, the preference information 403, the purchase information 404, and the retention information 405, respectively.

The advertisement providing system may store and maintain an advertisement of an advertiser in association with a content type. Also, the advertisement providing system may define and store a content type of each advertisement from the defined content types in advance.

In operation S203, the advertisement providing system may collect keywords and sort the collected keywords by category before defining the search intention for each keyword. The keywords to be collected may indicate a word indicating a marketing object of the advertiser in association with a name of a product or a brand. Also, keywords inputted at least predetermined number of times for a predetermined time may be collected.

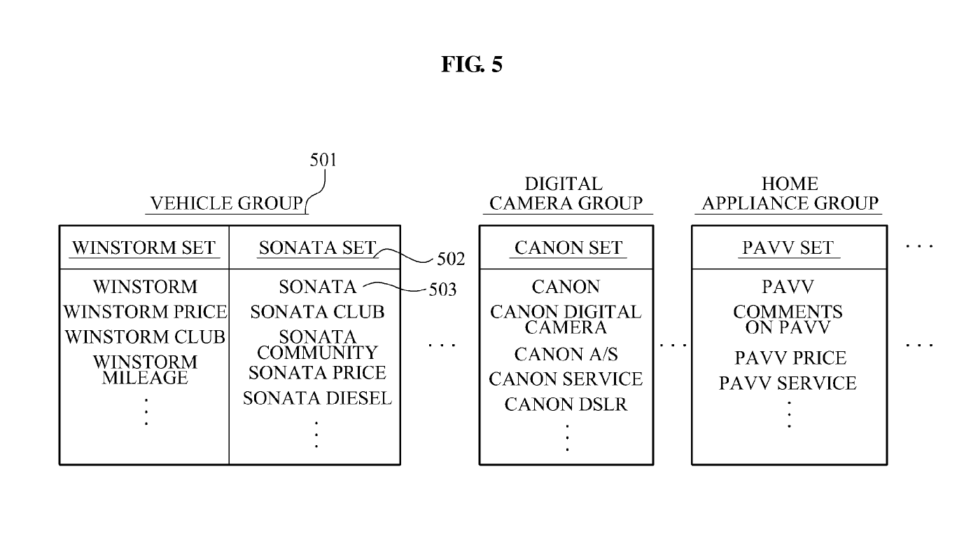

FIG. 5 is a diagram illustrating an operation of collecting keywords.

As illustrated in FIG. 5, the advertisement providing system may sort a category 501 with respect to a keyword depending on types of products, for example, a vehicle, a digital camera, home appliances, and the like. Also, the advertisement providing system may construct at least one keyword set 502 by selecting a keyword 503 associated with a particular brand or product from keywords of a same category.

In operation S204, the advertisement providing system may set the search intention appropriate for a characteristic of each of the collected keywords (each query). The advertisement providing system may ascertain a characteristic of an advertisement content associated with each of the keywords, and set the search intention based on the characteristic of the keyword and the characteristic of the advertisement content. That is, after selecting an advertisement content that has been clicked a number of times from the advertisement content associated with each of the keywords, the advertisement providing system may map the search intention, corresponding to a characteristic of the selected content and the characteristic of the keyword, to the corresponding keyword. It may be determined which search intention the keyword corresponds to through sorting in operation S201, and thus the search intention for each keyword may be determined.

The advertisement providing system may provide the advertisement content based on the search intention for each keyword and the content type for each search intention which are defined in operations S201 through S204.

When the user inputs a predetermined keyword, the advertisement providing system may determine a search intention corresponding to the inputted keyword from among the search intention for each keyword, and thereby may determine a content type corresponding to the determined search intention from among the content type for each search intention.

Also, the advertisement providing system may extract advertisement contents associated with the keyword, select an advertisement content corresponding to the determined content type from the advertisement contents, and thereby may generate an advertisement content list. That is, the advertisement providing system may determine the search intention, and present and provide the user with the advertisement content list corresponding to the determined search intention.

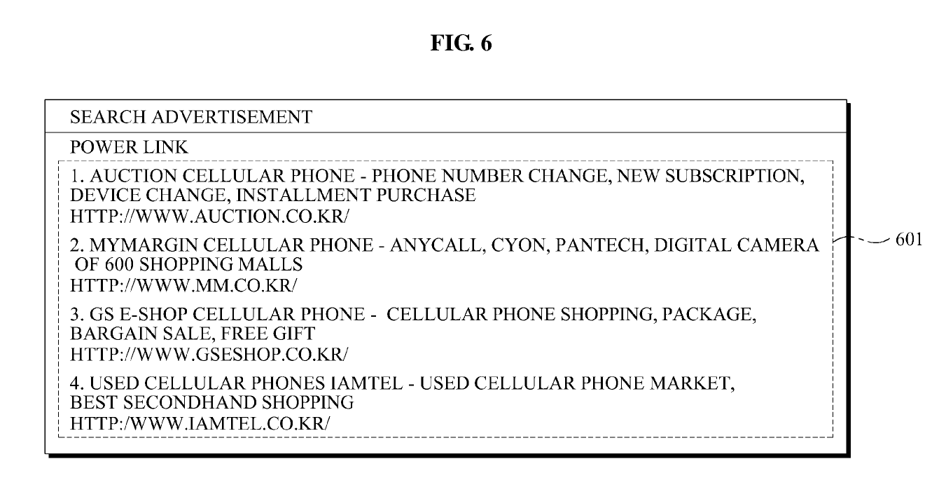

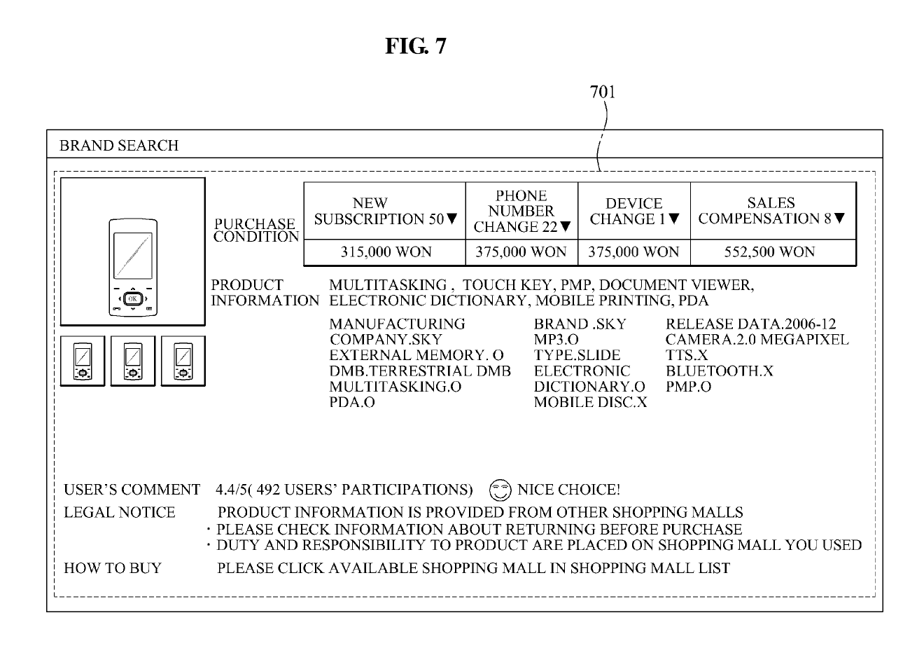

FIGS. 6 and 7 are diagrams illustrating examples of a screen providing an advertisement content based on a search intention of a user.

As illustrated in FIG. 6, a page link list associated with a search intention of a user may be displayed on a predetermined advertisement area 601. A page link list corresponding to at least one of awareness information, consideration information, preference information, purchase information, and retention information may be provided based on the search intention of the user in the advertisement area 601.

As illustrated in FIG. 7, a search list of a brand advertisement associated with the search intention of the user may be displayed on a predetermined advertisement area 701. An image associated with a keyword, and a brand search page may be provided based on the search intention of the user in the advertisement area 701. The brand search page may correspond to at least one of awareness information, consideration information, preference information, purchase information, and retention information.

As described above, an advertisement providing system according to an embodiment of the present invention may ascertain the search intention of the user based on the keyword inputted by the user, and selectively present an advertisement content highly associated with the determined search intention.

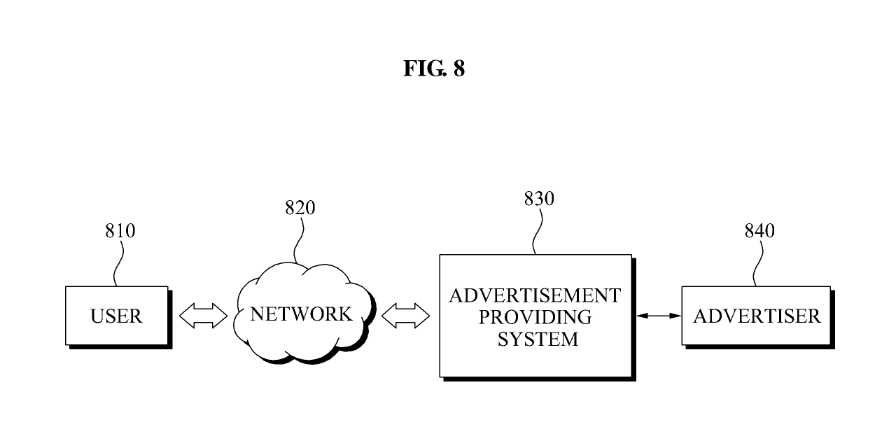

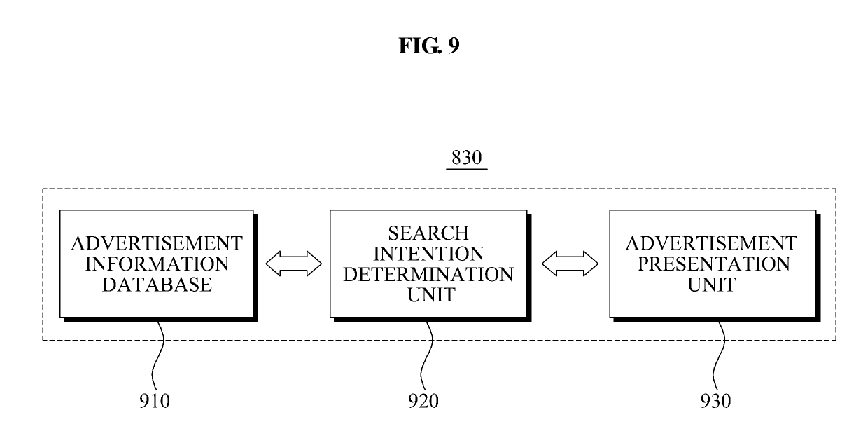

Hereinafter, an advertisement providing system to perform the advertisement providing method is described in detail. FIG. 8 is a diagram illustrating a relationship associated with an advertisement providing system 830 according to an embodiment of the present invention. FIG. 9 is a block diagram illustrating a configuration of an advertisement providing system 830 according to an embodiment of the present invention.

As illustrated in FIG. 8, a searcher, that is, a user 810 may have a terminal that maintains a connection to the advertisement providing system 830 through a network 820. Also, the user 810 may indicate an Internet user that may input a predetermined keyword in the advertisement providing system 830 through the terminal.

An advertiser 840 may be a contents provider managing a website on the network 820 using an Internet Protocol (IP) address, Uniform Resource Locator (URL), domain, and the like. The advertiser 840 may put an advertisement of the advertiser 840 through the advertisement providing system 830.

The advertisement providing system 830 may include a search engine to extract a predetermined number of advertisement lists corresponding to the keyword inputted by the user 810, and to present the advertisement lists on a screen.

As illustrated in FIG. 9, the advertisement providing system 830 may include an advertisement information database 910 and an advertisement providing unit.

The advertisement information database 910 may store and maintain an advertisement of an advertiser in association with a predetermined content type for each advertisement. Also, the advertisement information database 910 may store and maintain a predetermined search intention for each keyword and a content type for each search intention.

The search intention for each keyword may be defined as at least two stages, and may be set based on a characteristic of a keyword and a characteristic of an advertisement content associated with the keyword to define the search intention for each keyword.

Here, the search intention of the at least two stages may include an information collection stage intended for information acquisition in association with a purchase, and a purchase determination stage intended for an actual purchase. Also, the characteristic of the keyword may be divided into a keyword characteristic intended for information acquisition and a keyword characteristic intended for an actual purchase. The characteristic of the advertisement content may be divided into an information-oriented content characteristic and a purchase-oriented content characteristic.

Also, a content type of an advertisement content may be divided into at least two content types, and the content type of the advertisement content may be set corresponding to the defined search intention of each of the at least two stages. Accordingly, the content type for each search intention may be defined.

In this instance, the content type may be divided into contents providing information-oriented advertisement information and contents providing purchase-oriented advertisement information.

When a user 810 inputs a keyword, the advertisement providing unit may provide an advertisement content list based on a search intention of the inputted keyword. The advertisement providing unit may include a search intention determination unit 920 and an advertisement presentation unit 930.

The search intention determination unit 920 may determine the search intention of the keyword inputted by the user 810 based on the search intention for each keyword and the content type for each search intention stored in the advertisement information database 910. Also, the search intention determination unit 920 may determine a content type corresponding to the search intention.

The advertisement presentation unit 930 may generate an advertisement content list corresponding to the search intention from advertisement contents associated with the keyword, and present the generated advertisement content list.

Accordingly, the advertisement providing system according to an embodiment of the present invention may selectively provide an advertisement content highly associated with a search intention of a user by sorting a search intention for each keyword.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An advertisement providing method, comprising:
defining a search intention for each keyword and a content type for each search intention; and
providing, when a user inputs the keyword, an advertisement content list based on a search intention of the inputted keyword.

2. The advertisement providing method of claim 1, wherein the defining comprises:
defining the search intention as at least two stages;
collecting keywords; and
setting the search intention for each keyword in each of the at least two stages based on a characteristic of each of the keywords and a characteristic of an advertisement content associated with each of the keywords.

3. The advertisement providing method of claim 2, wherein the search intention includes an information collection stage for information acquisition in association with a purchase, and a purchase determination stage for an actual purchase.

4. The advertisement providing method of claim 2, wherein the characteristic of each of the keywords is divided into a keyword characteristic intended for information acquisition in association with a purchase and a keyword characteristic intended for an actual purchase, and the characteristic of the advertisement content is divided into an information-oriented content characteristic in association with the purchase and a purchase-oriented content characteristic.

5. The advertisement providing method of claim 2, wherein the collecting of the keywords comprises:
collecting keywords inputted at least predetermined number of times for a predetermined time; and
sorting the collected keywords by category.

6. The advertisement providing method of claim 5, wherein the collecting of the keywords further comprises:
selecting a keyword associated with a predetermined brand from the keywords sorted by category; and
sorting the selected keyword by brand and constructing a keyword set for each brand,
wherein the search intention for each keyword is set with respect to the keyword set for each brand.

7. The advertisement providing method of claim 2, wherein the defining of the search intention for each keyword and the content type for each search intention further comprises:
dividing a content type of an advertisement content into at least two content types; and
setting the content type corresponding to the defined search intention of each of the at least two stages.

8. The advertisement providing method of claim 7, wherein the content type of the advertisement content is divided into contents providing information-oriented advertisement information and contents providing purchase-oriented advertisement information.

9. The advertisement providing method of claim 7, wherein the providing of the advertisement content list comprises:
determining the search intention of the keyword inputted by the user;
determining the content type of the advertisement content corresponding to the search intention of the keyword;
generating the advertisement content list corresponding to the search intention from advertisement contents associated with the keyword; and
presenting the advertisement content list corresponding to the search intention.

10. A computer-readable recording medium storing a program for implementing the method according to claim 1.

11. An advertisement providing system, comprising:
a database storing an advertisement of an advertiser in association with a predetermined content type for each advertisement and storing a predetermined search intention for each keyword and a content type for each search intention; and
an advertisement providing unit providing, when a user inputs a keyword, an advertisement content list based on a search intention of the inputted keyword.

12. The advertisement providing system of claim 11, wherein the advertisement providing unit comprises:
a search intention determination unit determining the search intention of the inputted keyword and determining a content type corresponding to the search intention; and
an advertisement presentation unit generating an advertisement content list corresponding to the search intention from advertisement contents associated with the keyword and presenting the generated advertisement content list.

13. The advertisement providing system of claim 11, wherein the search intention is defined as at least two stages, and is set in each of the at least two stages based on a characteristic of each keyword and a characteristic of an advertisement content associated with each of the keywords after collecting the keywords.

14. The advertisement providing system of claim 13, wherein the search intention of the at least two stages includes an information collection stage intended for information acquisition in association with a purchase and a purchase determination stage intended for an actual purchase.

15. The advertisement providing system of claim 13, wherein the characteristic of each of the keywords is divided into a keyword characteristic intended for information acquisition and a keyword characteristic intended for an actual purchase, and the characteristic of the advertisement content is divided into an information-oriented content characteristic and a purchase-oriented content characteristic.

16. The advertisement providing system of claim 13, wherein the content type for each search intention is obtained by dividing a content type of an advertisement content into at least two content types, and the content type of the advertisement content is set corresponding to the defined search intention of each of the at least two stages.

17. The advertisement providing system of claim 16, wherein the content type is divided into contents providing information-oriented advertisement information and contents providing purchase-oriented advertisement information.
